(19) United States
(12) Patent Application Publication
(10) Pub. No.: US 2004/0182785 A1
(43) Pub. Date: Sep. 23, 2004

(54) Animal plasma process by precipitation

(75) Inventors: John H. Lee, Olathe, KS (US); James A. Coalson, Reedsburg, WI (US); Richard R. Field, Wonewoc, WI (US); Erwin C. Clark, Kansas City, MO (US)

Correspondence Address: John H. Lee, 1441 N Lucy Montgomery Way, Olathe, KS, 66061, US

(73) Assignees: Rigel Technology Corporation, Shawnee, KS (US); Merrick's Inc., Middleton, WI (US)

(21) Appl. No.: 10/767,307

(22) Filed: Jan. 30, 2004

Related U.S. Application Data
(63) Continuation-in-part of application No. 10/278,099, filed on Oct. 23, 2002.

(51) Int. Cl. B01D 61/02

(52) U.S. Cl. 210/639; 210/652; 210/743; 210/774; 210/806

(57) ABSTRACT

A method for processing liquid animal plasma or serum into two products of albumin rich fraction and immunoglobulin rich fraction by adding less than 1% sodium hexametaphosphate at preferred pH range from 4.1 to 4.5 and using a settling or centrifuge process is provides in this invention. The immunoglobulin rich product is used for health purposes. The albumin rich product is used as a protein, binding or gelling ingredient. The novel process in the invention is feasible for commercial production.

### CROSS-REFERENCE TO RELATED APPLICATION

This application is a continuation-in-part application of U.S. application Ser. No. 10/278,099, filed on Oct. 23, 2002.

Reference Cited:
U.S. Patent Documents

| | | | |
|---|---|---|---|
| 4486282 | December, 1984 | Bier | 204/529 |
| 4623541 | Nev., 1986 | Elliot et al. | 424/157.1 |
| 5043427 | August, 1991 | Leberre et al. | 530/370 |
| 5087695 | February, 1992 | McAuley | 424/177.1 |
| 5138034 | August, 1992 | Uemura et al. | 530/413 |
| 6093324 | July, 2000 | Bertoloni et al. | 210/635 |
| 6207807 | March, 2001 | Fassina et al. | 530/417 |
| 6281336 | August 2001 | Laursen et al. | 530/390.1 |
| 6498236 | December, 2002 | Lihme et al. | 530/387.1 |

### BACKGROUND OF THE INVENTION

Animal blood plasma, which is separated from animal red blood cells by a centrifugation process, is the major source of immunoglobulins. Immunoglobulins are the major source for antibodies against different diseases for animals and humans. Immunoglobulins have a biological function. Plasma has a light reddish color after the separation from red blood cells. The color of red blood cells is dark red. The protein level of the liquid plasma is normally about 7%. The total solids level is about 10%. Immunoglobulin level in the liquid plasma is normally about 1.1% in human plasma. Albumin level in the liquid plasma is normally about 3.65% in human plasma. Antibodies of most species have a molecular weight of 150,000 to 180,000. Electrophoretically, the isoelectric points of antibodies are usually between pH 6.3 and 7.3. Thus unlike the other plasma proteins, these molecules are almost electrically neutral at pH of the plasma. Newborn mammals do not appear to be able to make antibodies. Antibodies are the proteins synthesized by animals or humans in response to the presence of foreign substances. Proteins, polysaccharides, and nucleic acids are usually effective antigens (Stryer, 1975 and White et al., 1964). Immunoglobulins have a biological function due to passive immunity, which can be used as an immunoglobulin supplement. For example weaning piglets fed animal blood immunoglobulins had a faster daily weight gain, lower incidence of scours, and reduced mortality (Gaillard et al., 1985 and Hoerlein et al., 1957). In humans, the importance of immunoglobulins from cow colostrum in infant feeding was proven by clinical test results (Ballabriga, 1982). Immunoglobulin fraction is a good ingredient as a passive immunity agent for newborn mammals.

Animal (porcine or bovine) plasma is normally processed by concentrating it into higher solids level by ultrafiltration or evaporation process and dried into a powder product by a spray dryer. The spray dried plasma normally has a tan color and contains about 78% protein on a solids basis. Plasma product is used in the applications of milk replacer, immunoglobulin supplement, pet food, feed, food, and other products.

Immunoglobulins in plasma is only about 15.7% (1.1/7) on a protein basis. Albumin in the plasma is about 52.1% (3.65/7) on a protein basis. Immunoglobulins have a biological function due to passive immunity. The plasma also contains fibrin, which is developed over time by calcium and thrombin. Fibrin in a gel form effects the ultrafiltration and spray drying processes. If immunoglobulins can be separated from other plasma proteins at an economical processing cost, immunoglobulin products will be a better supplement for health applications. Over the years, people have made various attempts to recover immunoglobulins from animal or human plasma and fractions. US Pat. No. 6,498,236 (Lihmet et al., 2002) discloses a process to use a solid phase matrix at a total salt content corresponding to an ionic strength of at the most 2.0 and lyotropic salts in a concentration of at the most 0.4 M and to bind the immunoglobulins to the solid phase matrix. Then the bound immunoglobulins are eluted from the solid phase matrix. The absorption and elution processes on the solid matrix in production scale are at high processing cost. U.S. Pat. No. 6,281,336 (Laursen et al., 2001) discloses a process for producing immunoglobulins from a plasma protein fraction with the anion exchange chromatography and cation exchange chromatography. US Pat. No. 6,207,807 (Fassina et al., 2001) discloses a process to use an affinity solid chromatography with a peptide as a ligand to separate fluid immunoglobulins. U.S. Pat. No. 6,093,324 (Bertoloni et al., 2000) discloses a process for recovering immunoglobulin fraction from plasma on a macroporous anion exchange resin. U.S. Pat. No. 5,138,034 (Uemura et al., 1992) discloses a process for fractionating plasma proteins with 5-10% ethanol, anion exchanger, affinity chromatography, and 18-45% ethanol treatments. Pat. No. 5,087,695 (McAuley, 1992) discloses a process to produce a precipitate rich in immunoglobulins by contacting diluted serum with the chemical CuSOsub4. U.S. Pat. No. 5,043,427 (Leberre et al., 1991) discloses a process for fractionating animal proteins with a fatty acid of 6 to 14 carbon atoms such as carprylic acid under controlled pH and temperature. U.S. Pat. No. 4,623,541 (Elliot et al., 1986) discloses a process to use a selective two-step ammonium sulfate fractionation procedure at 20-30% and 35-50% to separate fibrin and immunoglobulins from porcine blood plasma. Two centrifuge processes are used to separate the precipitates. Then the immunoglobulin-containing sludge from the centrifuge step is redissolved by adding extra water. The final immunoglobulins are used in the formulation of milk replacers for artificial rearing of neonatal pigs to provide passive immunity to disease normally provided by sows' colostrum and later milk. However the method of preparation is still not economically feasible. U.S. Pat. No. 4,486,282 (Bier, 1984) discloses a process to precipitate plasma proteins with heavy metal ions and then to do a desalt treatment with electrodialysis.

Above processing methods have problems in the disposal of solvent, removal of high salt, expensive equipment, or high processing cost. The separation process in this invention provides an inexpensive and practical process for immunoglobulin separation from plasma or serum compared with other separation processing methods. For agricultural processes, one challenge is how to do the processes at a reasonable and economical processing cost, which can be accepted by the agricultural industry. It is different from pharmaceutical and biotechnology industries. The current invention provides a novel process to combine a precipitation process and settling or centrifuge process together at low processing cost. The liquid animal plasma, which is separated from the red blood cells, is treated with the precipitation process and set for a period of time such as overnight to separate the immunoglobulin rich fraction from animal plasma at the lowest processing cost. The immunoglobulin rich fraction is a clear solution when pH is above 4.5 and is concentrated by ultrafiltration process or evaporation process at low temperature and vacuum conditions. The immunoglobulin rich fraction is spray dried or further processed. The remaining fraction contains albumin, fibrin, lipid, and calcium phosphate, which have gel properties and may be used as a binding and gelling agent for sausage, non-toxic glue, and cooked pet foods.

### SUMMARY OF THE INVENTION

The present invention overcomes the problems of other patents and references and provides a novel process to separate animal plasma or serum into two functional products by combining a precipitation process and settling or centrifuge process together processed in the one-stage process at an economical cost. The two functional products of albumin rich fraction and immunoglobulin rich fraction can be used for the applications according to their different functions. The objective of the present invention is to provide the process method, which are convenient and economical to use in the agricultural industry.

Normal liquid animal plasma, which is treated with anticoagulant(s) and separated from animal red blood cells, is mixed with sodium hexametaphosphate, at a level of less than 1% solids against normal liquid plasma or serum weight. Sodium hexametaphosphate is a food-grade, feed-grade or technical-grade chemical, which can be liquid or solid form. If a liquid form such as 30% concentration of sodium hexametaphosphate is used, then a level of less than 3.33%, which matches 1% on the solids against normal liquid plasma or serum weight basis, is used. Liquid form is easily mixed with the plasma within a few minutes. The pH is adjusted to a range from 3.5 to 4.9. The preferred range is 4.1 to 4.5. The color is changed from plasma red to creamy. Then a settling process is used to let the mixture in a tank set without disruption for a period of time such as overnight or a centrifuge process is used to separate the precipitate and liquid into two products of immunoglobulin rich fraction and albumin rich fraction. The immunoglobulin rich fraction is the liquid phase. Albumin rich fraction is the precipitate sludge solid phase. The sludge solid phase also contains components such as fibrin, lipoapoproteins, and calcium hexametaphosphate. The settling process is effected by the factors such as liquid viscosity, pH, chemical concentration, solids content, and protein level. The clear solution of immunoglobulin rich fraction is further concentrated to a higher solids level such as 20-30% by ultrafiltration, nanofiltration or evaporation after the pH is adjusted to above 4.5, which reduces the drying cost.

Above normal animal plasma has a solids level about 10% and protein level about 7%. If animal plasma liquid has a lower or higher protein level than normal animal plasma, sodium hexametaphosphate is adjusted to a lower or higher level. For example, if normal plasma is concentrated to higher protein level such as 10.5%, the plasma is then processed with the same processing method. The usage of sodium hexametaphosphate is increased according to the rate increase from less than 1% to 1.5%. When the plasma has higher solids level and protein level, it is not easy to separate the mixture by settling into liquid and precipitate products because the viscosity increases with higher solids and protein levels. The settling process is at the lowest processing cost. Liquid animal serum without fibrin and fibrinogen is processed with the same processing method as liquid animal plasma. Other ingredients such as egg or whey protein may be mixed with plasma or immunoglobulin rich fraction and processed together.

The albumin rich fraction is a good product for different applications such as cooked pet foods, non-toxic glue, sausage, and binding or gelling purposes (Ockerman and Hansen, 2000) besides blending with liquid plasma. The two products have their own functions and applications. The values of the two products are increased by the value-added process in this invention.

Another benefit in the process is the improved color with above process. Liquid plasma or serum still has a light reddish color, which is lighter than whole blood and red blood cells. After liquid animal plasma is mixed with sodium hexametaphosphate, at a level of less than 2% solids against liquid plasma or serum weight and pH is adjusted to a range from 2.5 to 4.9 with a preferred range from 3.8 to 4.5, the color of the mixture liquid is changed from light reddish color to a creamy color. Also low level hydrogen peroxide is added to improve the color into more white than creamy color. Hydrogen peroxide is usually used to reduce microorganisms. A homogenizer may be used to make the liquid more uniform before a spray drying process. The mixture at pH range from 3.8 to 4.5 is the uniform liquid. The high solids level in the liquid plasma reduces the drying cost because less moisture is evaporated. It is better to concentrate the plasma or serum to higher solids level, and then the color improvement is processed with the processing method.

The present novel separation process for animal plasma or serum is practical and economical, which is feasible for commercial production.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### EXAMPLE 1

Liquid bovine plasma (500 grams at 18% solid) was mixed with sodium hexametaphosphate (10 grams at 30% concentration). The added level of sodium hexametaphosphate solids against the liquid plasma weight (18% solids) was 0.6% (10×0.3/500). The pH of mixture was adjusted from 6.7 to 4.1 with 30% hydrochloric acid and mixed for 15 minutes. The mixture was a uniform liquid with a creamy color. Then the precipitate and liquid mixture was centrifuged to separate the precipitate solid phase and liquid phase (immunoglobulin rich fraction). The liquid was adjusted to pH 6.5. The rate of immunoglobulin G against total protein was 35.4% in the liquid immunoglobulin rich fraction.

### EXAMPLE 2

Liquid porcine plasma (300 grams at 13% solid) was mixed with sodium hexametaphosphate ( 2.4 grams at 33% concentration). The added level of sodium hexametaphosphate solids against the liquid plasma weight (13% solids) was 0.24% (2.4×0.3/300). The pH of mixture was adjusted from 6.8 to 4.3 with 30% hydrochloric acid and mixed for 10 minutes. The precipitate and liquid mixture was set overnight. Then the precipitation sludge phase and liquid phase (immunoglobulin rich fraction) were separated. The liquid was adjusted to pH 6.3. The rate of immunoglobulin G against total protein was 31.5% in the liquid immunoglobulin rich fraction.

### EXAMPLE 3

Liquid bovine plasma (2000 lbs at 10% solid) was mixed with sodium hexametaphosphate (10 lbs at 30% concentration). The added level of sodium hexametaphosphate solids against the liquid plasma weight (10% solids) was 0.15% (10×0.3/2000). The pH of the mixture was adjusted from 6.7 to 4.3 with 30% hydrochloric acid and mixed for 10 minutes. The mixture was a uniform liquid with a creamy color. Then the precipitate and liquid mixture was set overnight. Then the precipitation sludge phase and liquid phase (immunoglobulin rich fraction) were separated. The liquid was clear solution after adding sodium hydroxide and was concentrated to 24.0% solids with ultrafiltration process. Partial liquid at 24.0% solids was dried with a spray dryer. The powder product had protein (79.9%) and immunoglobulins G (33.0%) on a solids basis. Another partial liquid at 24.0% solids was mixed with whey protein concentration at 85:15 rate and was dried with a spray dryer. The powder product had protein (73.6%) and immunoglobulins G (28.0%) on a solids basis.

What is claimed is:

1. A method of preparing liquid animal plasma or serum into two products comprising mixing liquid animal plasma or serum with sodium hexametaphosphate at less than 1% solids against liquid animal plasma or serum weight, adjusting pH to a range 3.5 to 4.9 with preferred range from 4.1 to 4.5, and then setting the mixture to separate the liquid and precipitate products.

2. The method of claim 1 wherein the liquid product is processed by ultrafiltration or evaporation process to increase the solids level before a drying process.

3. The method of claim 1 wherein the liquid product is further processed.

4. The method of claim 1 wherein the liquid product is used as a health or nutritional ingredient.

5. The method of claim 1 wherein whey protein or egg protein is mixed and processed with the liquid product or plasma.

6. The method of claim 1 wherein the precipitate product is used as a protein, binding or gelling ingredient.

7. The method of claim 1 wherein the products are in wet or dry form.

8. A method of preparing liquid animal plasma or serum into two products comprising mixing liquid animal plasma or serum with sodium hexametaphosphate at less than 1% solids against liquid plasma or serum weight, adjusting pH to a range 3.5 to 4.9 with preferred range from 4.1 to 4.5, and then centrifuging the mixture to separate the liquid and precipitate products.

9. The method of claim 8 wherein the liquid product is processed by ultrafiltration or evaporation process to increase the solids level before a drying process.

10. The method of claim 8 wherein the liquid product is further processed.

11. The method of claim 8 wherein the liquid product is used as a health or nutritional ingredient.

12. The method of claim 8 wherein whey protein or egg protein is processed with the liquid or plasma together.

13. The method of claim 8 wherein the precipitate product is used as a protein, binding or gelling ingredient.

14. The method of claim 8 wherein the products are in wet or dry form.

15. A method of changing liquid animal plasma or serum from a light reddish color into a creamy color comprising mixing liquid animal plasma or serum with sodium hexametaphosphate at less than 2% solids against liquid plasma or serum weight, adjusting pH to a range 2.5 to 4.9 with prefer range from 3.8 to 4.5, and then forming the liquid product with the creamy color.

16. The method of claim 15 wherein the plasma or serum is concentrated to increase the solids level.

17. The method of claim 15 wherein whey protein, egg protein, hydrogen peroxide, or oil used in the process.

18. The method of claim 15 wherein a homogenizer is used to form uniform liquid before a spray drying process.

19. The method of claim 15 wherein the product is in wet or dry form.
